(19) United States
(12) Patent Application Publication
(10) Pub. No.: US 2007/0089265 A1
(43) Pub. Date: Apr. 26, 2007

(54) Lockable wheel assembly and cart including the same

(76) Inventor: Paul Lin, Yung-Kang City (TW)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/256,367

(22) Filed: Oct. 21, 2005

(51) Int. Cl. B60B 33/00

(52) U.S. Cl. 16/35 R

(57) ABSTRACT

A lockable wheel assembly includes a stationary member, a swivel member, a wheel, and a locking device. The stationary member is adapted to be mounted fixedly to a deck of a cart, and is formed with a notch. The swivel member is formed with a trench and is mounted rotatably to the stationary member about a vertical axis to register selectively the trench with the notch. The swivel member has a wheel support. The wheel is mounted to the wheel support and is rotatable about a horizontal axis, which is perpendicular to the vertical axis. The locking device includes an engaging unit mounted pivotably to the stationary member. The engaging unit may engage the notch and the trench to prevent the swivel member from pivoting, and may be removed from the notch and the trench such that the swivel member is pivotable relative to the stationary member.

### BACKGROUND OF THE INVENTION

1. Field of the Invention

The present invention relates to a lockable wheel assembly. More particularly, the present invention relates to a lockable wheel assembly and a cart including the lockable wheel assembly, in which the lockable wheel assembly may be easily locked such that it is oriented in a specific direction.

2. Description of the Related Art

Wheel assemblies are typically mounted to a cart to facilitate movement of the cart. With the provision of the wheel assemblies, a user is able to easily transport articles placed on the cart by pushing or pulling on a handle of the cart. However, since the wheel assemblies are pivotally mounted to the deck, i.e., freely pivotable 360 degrees about lines normal to the surface on which the cart travels, the wheel assemblies are likely to be oriented independently in different directions, particularly when the cart is traveling on uneven terrain. This makes it difficult for the user to control the direction of the cart, and in some instances, may even lead to tipping of the cart.

### SUMMARY OF THE INVENTION

Therefore, the object of this invention is to provide a lockable wheel assembly and a cart including the same, in which the lockable wheel assembly may be easily locked such that the lockable wheel assembly is oriented in a specific direction.

The lockable wheel assembly of this invention is adapted to be mounted to a deck of a cart, and comprises: a stationary member adapted to be mounted fixedly to the deck, and formed with a notch that extends inwardly from an outer periphery of the stationary member; a swivel member formed with a trench that extends inwardly from an outer periphery of the swivel member, and mounted rotatably to the stationary member about avertical axis to register selectively the trench with the notch in the stationary member, the swivel member having a wheel support extending therefrom; awheel mounted to the wheel support of the swivel member and rotatable about a horizontal axis, which is perpendicular to the vertical axis; and a locking device including an engaging unit mounted pivotably to the stationary member and pivotable between first and second positions.

The engaging unit engages the notch in the stationary member and the trench in the swivel member such that the swivel member is prevented from pivoting relative to the stationary member when the engaging unit is at the first position, and the engaging unit is removed from the notch in the stationary member and the trench in the swivel member such that the swivel member is pivotable relative to the stationary member and about the vertical axis when the engaging unit is at the second position.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a cart according to a first preferred embodiment of the present invention;

FIG. 2 is a perspective view of a lockable wheel assembly of FIG. 1, depicted in a state secured to a mount of the cart;

FIG. 3 is fragmentary, partly exploded perspective view of the lockable wheel assembly of FIG. 2;

FIG. 4 is a partly sectional schematic side view of the lockable wheel assembly of FIG. 2, illustrating an engaging unit at a first position;

FIG. 5 is a partly sectional schematic side view of the lockable wheel assembly of FIG. 2, illustrating the engaging unit at a second position; and

FIG. 6 is a fragmentary perspective view of a cart according to a second preferred embodiment of the present invention.

### DETAILED DESCRIPTION OF THE PREFERRED EMBODIMENTS

Before the present invention is described in greater detail, it should be noted that like elements are denoted by the same reference numerals throughout the disclosure.

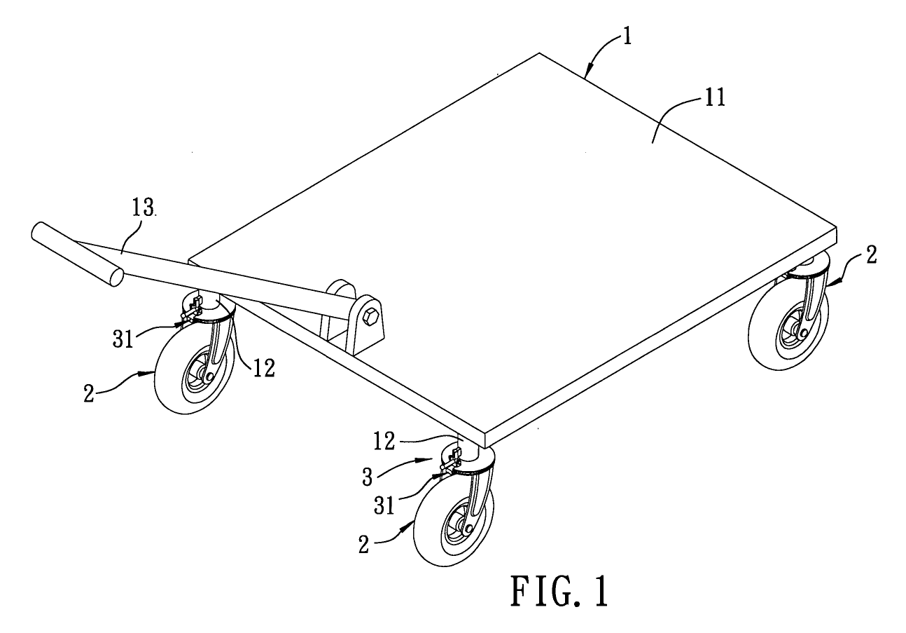

Referring to FIG. 1, a cart 1 according to a first preferred embodiment of the present invention includes a deck 11 having upper and lower surfaces, four mounts 12 extending integrally and downwardly from the lower surface of the deck 11 respectively at four corner portions of the deck 11, a handle 13 mounted to the upper surface of the deck 11 and manipulated by a user to push or pull the cart 1, and four lockable wheel assemblies 2 mounted respectively to the mounts 12.

Although the deck 11 is depicted as an integral planar element, the present invention is not limited in this respect and the deck 11 may be realized, for example, by adjacently interconnecting a plurality of boards or through use of a wheelbarrow-type container having lateral walls. Furthermore, the mounts 12 and the lockable wheel assemblies 2 connected thereto may be respectively and correspondingly increased or decreased in number, depending on the desired application of the cart 1.

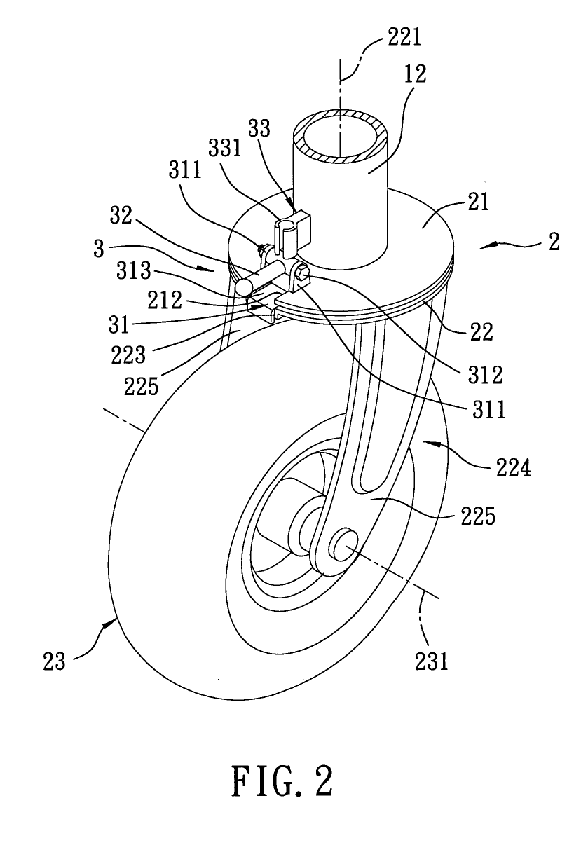

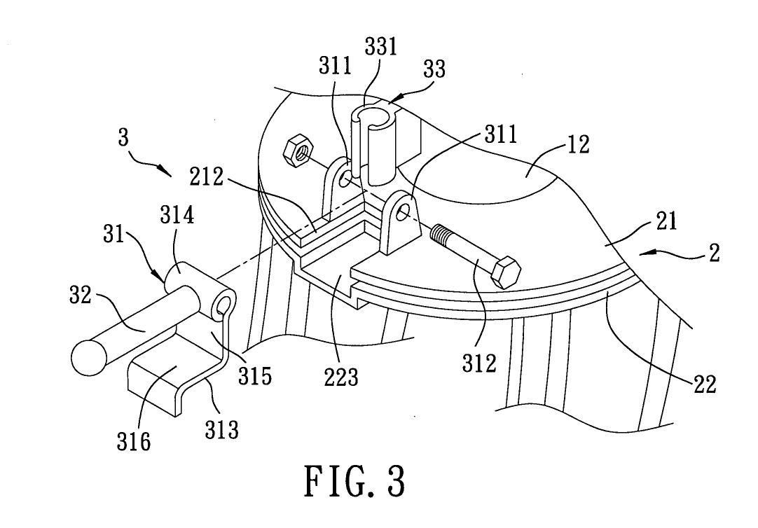

With additional reference to FIGS. 2, 3, and 4, each of the lockable wheel assemblies 2 includes a stationary member 21, a swivel member 22, a wheel 23, and a locking device 3. Since the lockable wheel assemblies 2 are identical in structure, only one of the lockable wheel assemblies 2 will be described below.

The stationary member 21 is mounted fixedly to a corresponding one of the mounts 12 of the deck 11, and is formed with a notch 212 that extends inwardly from an outer periphery of the stationary member 21.

The swivel member 22 is formed with a trench 223 that extends inwardly from an outer periphery of the swivel member 22. The swivel member 22 is mounted rotatably to the stationary member 21 about a vertical axis 221. Since conventional configurations may be used for the pivot connection between the swivel member 22 and the stationary member 21, a detailed description thereof will be omitted herein for the sake of brevity. The trench 223 in the swivel member 22 is selectively registered with the notch 212 in the stationary member 21. The swivel member 22 includes a wheel support 224 that extends integrally and downwardly from the swivel member 22. The wheel support 224 may be configured as a pair of support plates 225 that extend downwardly from opposite sides of the swivel member 22.

The wheel 23 is mounted to a bottom end portion of the support plates 225 of the wheel support 224. The wheel 23 is rotatable about a horizontal axis 231, which is perpendicular to the vertical axis 221.

The locking device 3 includes an engaging unit 31, a control element 32, a clasping unit 33, a pair of spaced-apart connectors 311, and a fastener 312.

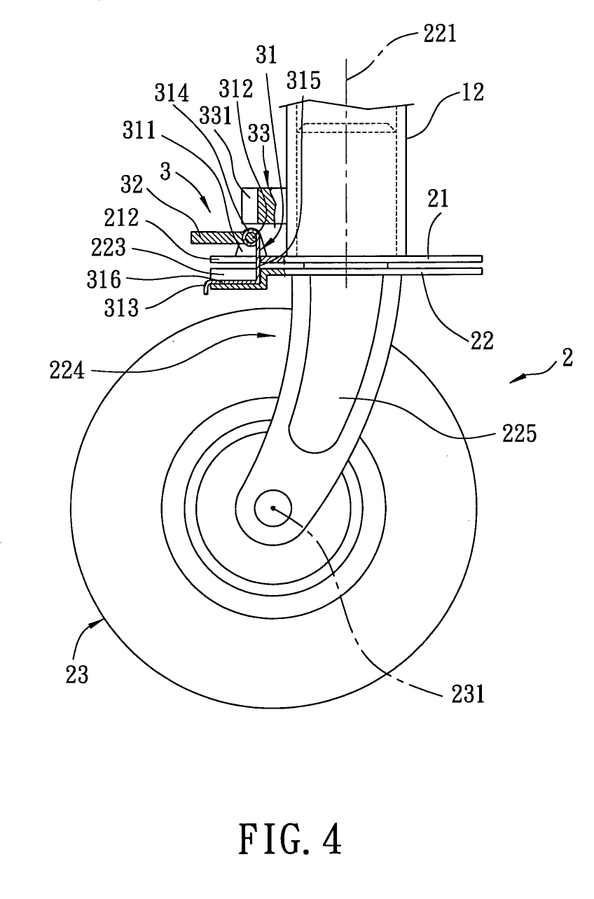

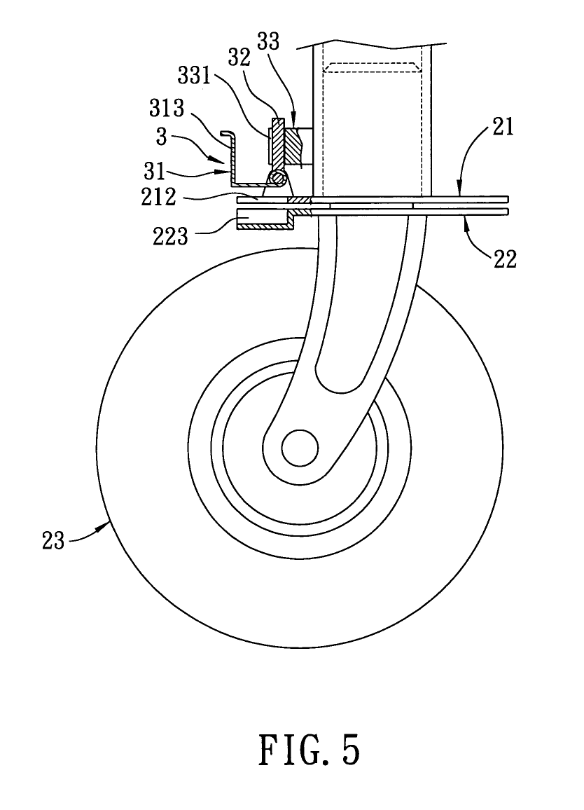

The engaging unit 31 of the locking device 3 is mounted pivotably to the stationary member 21, and is pivotable between first and second positions. The engaging unit 31 engages the notch 212 in the stationary member 21 and the trench 223 in the swivel member 22 such that the swivel member 22 is prevented from pivoting relative to the stationary member 21 when the engaging unit 31 is at the first position (see FIG. 4). When at the second position (see FIG. 5), on the other hand, the engaging unit 31 is removed from the notch 212 in the stationary member 21 and the trench 223 in the swivel member 22 such that the swivel member 22 is pivotable relative to the stationary member 21 and about the vertical axis 221.

The engaging unit 31 includes a catch member 313. The catch member 313, in turn, includes a pivot section 314 pivotally sleeved on the fastener 312, a first catch section 315 extending downwardly from the pivot section 314 toward and into the notch 212 and the trench 223 when the engaging unit 31 is at the first position, and a second catch section 316 extending from a bottom end of the first catch section 315 along the trench 223 when the engaging unit 31 is at the first position.

The control element 32 of the locking device 3 is mounted to the engaging unit 31, and is manipulated by a user to control movement of the engaging unit 31 between the first and second positions.

The clasping unit 33 of the locking device 3 is mounted to a corresponding mount 12 of the deck 11. The clasping unit 33 removably secures the engaging unit 31 at the second position. In this embodiment, the clasping unit 33 includes an elastic C-shaped latch member 331 into which the control element 32 may be removably inserted to thereby secure removably the corresponding engaging unit 31 at the second position.

The connectors 311 of the locking device 3 are mounted to the stationary member 21 on opposite sides of the notch 212. The fastener 312 of the locking device 3 is used to pivotally mount the pivot section 314 of the engaging unit 31 to the connectors 311.

When the engaging unit 31 of the locking device 3 is at the first position, the swivel member 22 is prevented from pivoting relative to the stationary member 21. Hence, the wheel assembly 2 is locked in a state aimed in a specific direction, which is a front-to-rear direction in the first preferred embodiment. However, when the engaging unit 31 of the locking device 3 is at the second position, the swivel member 22 is pivotable relative to the stationary member 21 and about the vertical axis 221. At this time, the control element 32 of the locking device 3 may be removably secured by the clasping unit 33 to thereby maintain the engaging unit 31 (to which the control element 32 is connected) at the second position, as best shown in FIG. 5.

In the first preferred embodiment, although each of the lockable wheel assemblies 2 is described as being identical in structure, it may be possible to provide only a select number of the lockable wheel assemblies 2 on the cart 1. Preferably, there are at least two of the lockable wheel assemblies 2 at the front of the cart 1.

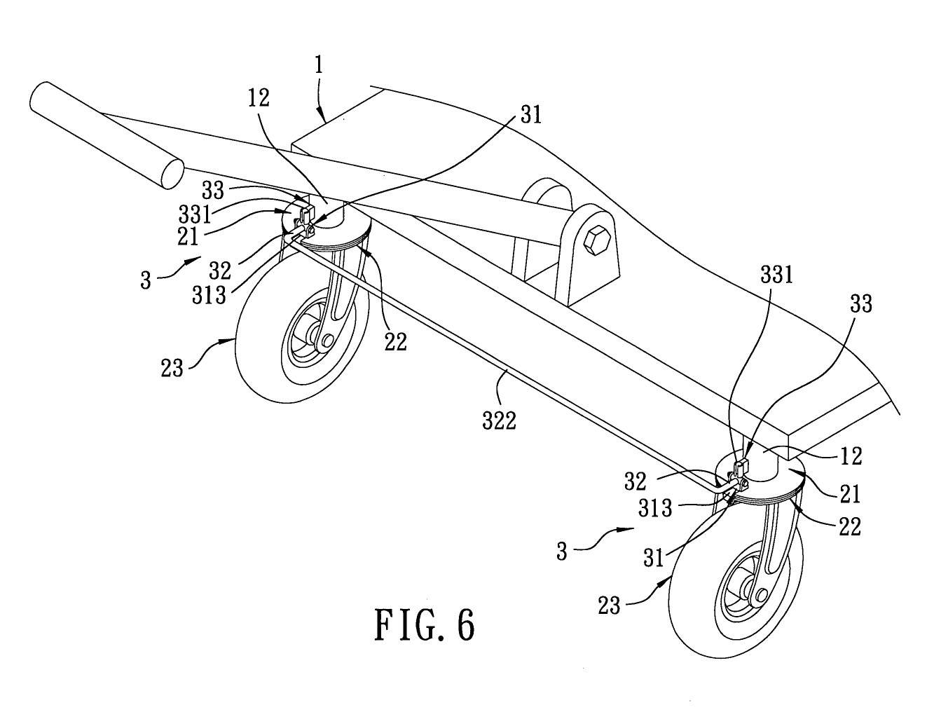

Referring to FIG. 6, a cart 1 according to a second preferred embodiment of the present invention is substantially the same as the cart 1 of the first preferred embodiment. However, in this embodiment, the cart 1 further includes a bridging member 322 interconnecting a pair of the control elements 32 of two of the lockable wheel assemblies 2. As a result, the bridging member 322 may be manipulated by the user to simultaneously operate two of the locking devices 3. In the case where the cart 1 is provided with more than two of the lockable wheel assemblies 2, the bridging member 322 may be configured to interconnect the control elements 32 of all of the lockable wheel assemblies 2.

With the use of the cart 1 employing the lockable wheel assemblies 2 as described above, since at least one, and preferably two or more of the lockable wheel assemblies 2 may be locked in a state aimed in a specific direction, the user may easily control the cart 1. This proves particularly useful when the cart 1 is traveling over uneven terrain. Furthermore, tipping of the cart 1 may be avoided.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A lockable wheel assembly adapted to be mounted to a deck of a cart, said lockable wheel assembly comprising:
a stationary member adapted to be mounted fixedly to the deck, and formed with a notch that extends inwardly from an outer periphery of said stationary member;
a swivel member formed with a trench that extends inwardly from an outer periphery of said swivel member, and mounted rotatably to said stationary member about a vertical axis to register selectively said trench with said notch in said stationary member, said swivel member having a wheel support extending therefrom;
a wheel mounted to said wheel support of said swivel member and rotatable about a horizontal axis, which is perpendicular to the vertical axis; and
a locking device including an engaging unit mounted pivotably to said stationary member and pivotable between first and second positions, said engaging unit engaging said notch in said stationary member and said trench in said swivel member such that said swivel member is prevented from pivoting relative to said stationary member when said engaging unit is at the first position, said engaging unit being removed from said notch in said stationary member and said trench in said swivel member such that said swivel member is pivotable relative to said stationary member and about the vertical axis when said engaging unit is at the second position.

2. The lockable wheel assembly of claim 1, wherein said locking device further includes a control element mounted to said engaging unit and manipulated by a user to control movement of said engaging unit between the first and second positions.

3. The lockable wheel assembly of claim 2, wherein said locking device further includes a clasping unit for removably securing said engaging unit at the second position.

4. The lockable wheel assembly of claim 3, wherein said clasping unit is adapted to be mounted to the deck of the cart, and includes an elastic C-shaped latch member into which said control element may be removably inserted to thereby secure removably said engaging unit at the second position.

5. The lockable wheel assembly of claim 1, wherein said locking device further includes a pair of spaced-apart connectors mounted to said stationary member on opposite sides of said notch, and a fastener for pivotally mounting said engaging unit to said connectors.

6. The lockable wheel assembly of claim 5, wherein said engaging unit includes a catch member having a pivot section pivotally sleeved on said fastener, a first catch section extending downwardly from said pivot section toward and into said notch and said trench when said engaging unit is at the first position, and a second catch section extending from a bottom end of said first catch section along said trench when said engaging unit is at the first position.

7. A cart, comprising:
a deck; and
a pair of lockable wheel assemblies, each including
a stationary member mounted fixedly to said deck, and formed with a notch that extends inwardly from an outer periphery of said stationary member,
a swivel member formed with a trench that extends inwardly from an outer periphery of said swivel member, and mounted rotatably to said stationary member about a vertical axis to register selectively said trench with said notch in said stationary member, said swivel member having a wheel support extending therefrom,
a wheel mounted to said wheel support of said swivel member and rotatable about a horizontal axis, which is perpendicular to the vertical axis, and
a locking device including an engaging unit mounted pivotably to said stationary member and pivotable between first and second positions, and a control element mounted to said engaging unit, said engaging unit engaging said notch in said stationary member and said trench in said swivel member such that said swivel member is prevented from pivoting relative to said stationary member when said engaging unit is at the first position, said engaging unit being removed from said notch in said stationary member and said trench in said swivel member such that said swivel member is pivotable relative to said stationary member and about the vertical axis when said engaging unit is at the second position, said control element being manipulated by a user to control movement of said engaging unit between the first and second positions.

8. The cart of claim 7, further comprising a bridging member interconnecting said control elements of said locking devices of said lockable wheel assemblies.

9. The cart of claim 8, wherein said locking device of at least one of said lockable wheel assemblies further includes a clasping unit for removably securing said engaging units of said locking devices of said lockable wheel assemblies at the second position.

10. The cart of claim 9, wherein said clasping unit is mounted to said deck, and includes an elastic C-shaped latch member into which said control element of a corresponding said locking device may be removably inserted to thereby secure removably said engaging units of said locking devices of said lockable wheel assemblies at the second position.
